(19) United States
(12) Patent Application Publication
(10) Pub. No.: US 2019/0059331 A1
(43) Pub. Date: Feb. 28, 2019

(54) SAFETY PET COLLAR DEVICE

(71) Applicant: Taiwan Tarky Products Inc., Taichung (TW)

(72) Inventor: Fong-O LAI, Taichung (TW)

(21) Appl. No.: 15/684,982

(22) Filed: Aug. 24, 2017

(51) Int. Cl. A01K 27/00; A44B 11/25

(52) U.S. Cl. CPC A01K 27/001; A44B 11/006; A44B 11/25

(57) ABSTRACT

A pet collar device includes a belt member having two end portions, a male buckle device attached to one of the end portions of the belt member, and a female buckle device having a carrier, a female element is extended from the carrier for engaging with the male element, and two flaps are extended from the carrier and spaced from each other for forming a space between the flaps, and for receiving the other end portion of the belt member, and a casing includes a compartment formed in the casing for receiving and engaging with the other end portion of the belt member and the flaps and for forcing the flaps to engage with the belt member. The male element is extended into a chamber of a receptacle for engaging with an opening of the female element.

### BACKGROUND OF THE INVENTION

### 1. Field of the Invention

The present invention relates to a pet collar device, and more particularly to a safety pet collar device including an improved structure or configuration for preventing the belt member from being shortened and for preventing the pet from being hurt by the pet collar device inadvertently.

### 2. Description of the Prior Art

Typical pet collar devices comprise a belt member for engaging onto the neck portion of the pet, and a female buckle element and a male buckle element attached or mounted or secured to the end portions of the belt member for solidly and stably anchoring or retaining or positioning the pet collar device to the neck portion of the pet.

For example, U.S. Pat. No. 5,701,849 to Suchowski et al., U.S. Pat. No. 6,834,621 to O'Neill, U.S. Pat. No. 6,948,220 to Chen, U.S. Pat. No. 7,617,801 to Wang, U.S. Pat. No. 8,726,850 to Rosenquist et al., U.S. Pat. No. 9,192,145 to Kissel, Jr., and U.S. Pat. No. 9,545,083 to Kissel, Jr. disclose several of the typical pet collar devices each also comprising a female buckle element and a male buckle element firmly or slidably attached or mounted or secured to the end portions of a belt member for engaging onto the neck portion of the pet, and for solidly and stably anchoring or retaining or positioning the pet collar device to the neck portion of the pet and for preventing the pet collar device from being disengaged or separated from the neck portion of the pet inadvertently.

For example, as shown in FIGS. 9 and 10, one of the typical pet collar devices comprises a belt member 90, and a buckle element 91 attached or mounted or secured to the belt member for engaging with the neck portion of the pet, and for anchoring or retaining or positioning the pet collar device to the neck portion of the pet.

However, the belt member may have a good chance to be shortened by the other objects or the like inadvertently such that the pet may have a good chance to be hurt by the pet collar device inadvertently.

The present invention has arisen to mitigate and/or obviate the afore-described disadvantages of the conventional pet collar devices or the like.

### SUMMARY OF THE INVENTION

The primary objective of the present invention is to provide a safety pet collar device including an improved structure or configuration for preventing the belt member from being shortened and for preventing the pet from being hurt by the pet collar device inadvertently.

In accordance with one aspect of the invention, there is provided a pet collar device comprising a belt member including a first end portion and a second end portion, a male buckle device attached to the first end portion of the belt member, and including a male element, a female buckle device including a carrier, a female element extended from the carrier for engaging with the male element, and two flaps extended from the carrier and spaced from each other for forming a space between the flaps, and for receiving the second end portion of the belt member, and a casing including a compartment formed in the casing for receiving and engaging with the second end portion of the belt member and the flaps and for forcing the flaps to engage with the second end portion of the belt member, and for allowing the second end portion of the belt member and the flaps of the female buckle device to be solidly and stably secured and retained together, for preventing the belt member from being shortened and for preventing the pet from being hurt by the pet collar device inadvertently.

The male buckle device includes a receptacle having a chamber formed in the receptacle, and the male element is extended into the chamber of the receptacle for engaging with the female element of the female buckle device and for detachably attaching or securing or maintaining the male element to the female element of the female buckle device.

The male element includes a circular cross section, and the female element includes a circular opening engaged with the circular male element and for allowing the male buckle device and the female buckle device to be pivoted or rotated relative to each other.

The flaps each include one or more teeth extended into the space that is formed between the flaps for engaging with the second end portion of the belt member and for solidly securing the belt member to the female buckle device, and the casing may force the teeth of the flaps to engage into the second end portion of the belt member, for allowing the second end portion of the belt member and the flaps of the female buckle device to be solidly and stably secured and retained together, and for preventing the second end portion of the belt member from being disengaged or separated from the flaps of the female buckle device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a safety pet collar device in accordance with the present invention;

FIG. 2 is an enlarged partial perspective view of the safety pet collar device;

FIG. 3 is a partial exploded view of the safety pet collar device;

FIG. 4 is another partial exploded view of the safety pet collar device;

FIG. 5 is a further partial exploded view of the safety pet collar device;

FIG. 6 is a partial cross sectional view of the safety pet collar device, taken along lines 6-6 of FIG. 2;

FIG. 7 is another partial cross sectional view of the safety pet collar device, taken along lines 7-7 of FIG. 2;

FIG. 8 is a further partial cross sectional view similar to FIG. 7, illustrating the operation of the safety pet collar device;

FIG. 9 is a perspective view illustrating a typical pet collar device; and

FIG. 10 is an enlarged partial perspective view of the typical pet collar device.

### DETAILED DESCRIPTION OF THE PREFERRED EMBODIMENT

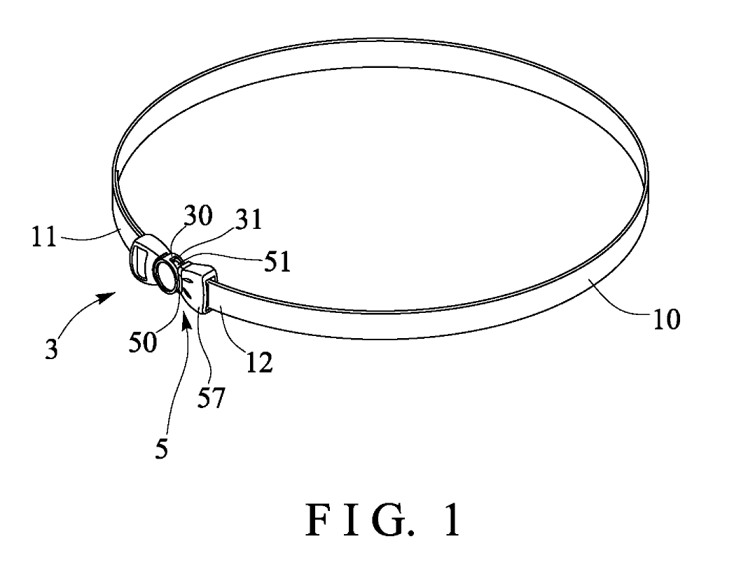

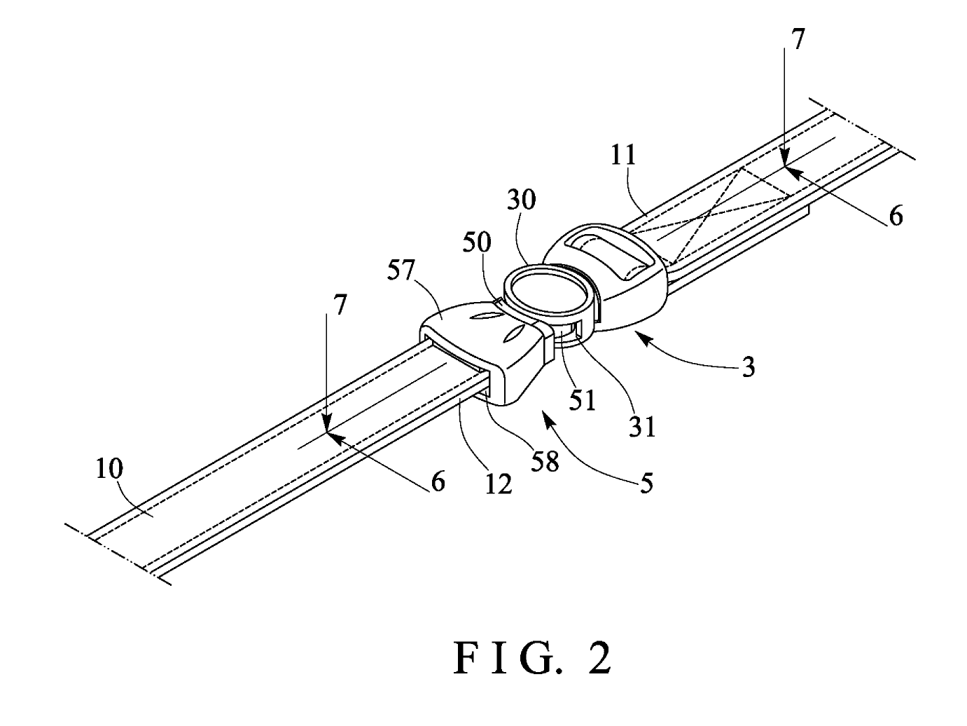

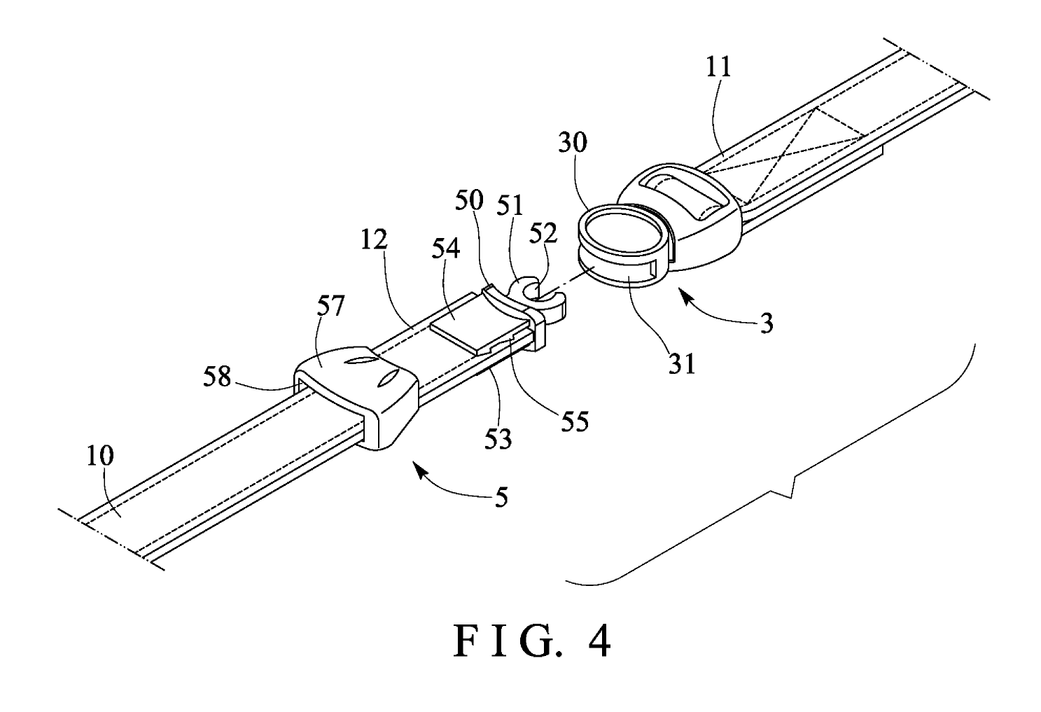

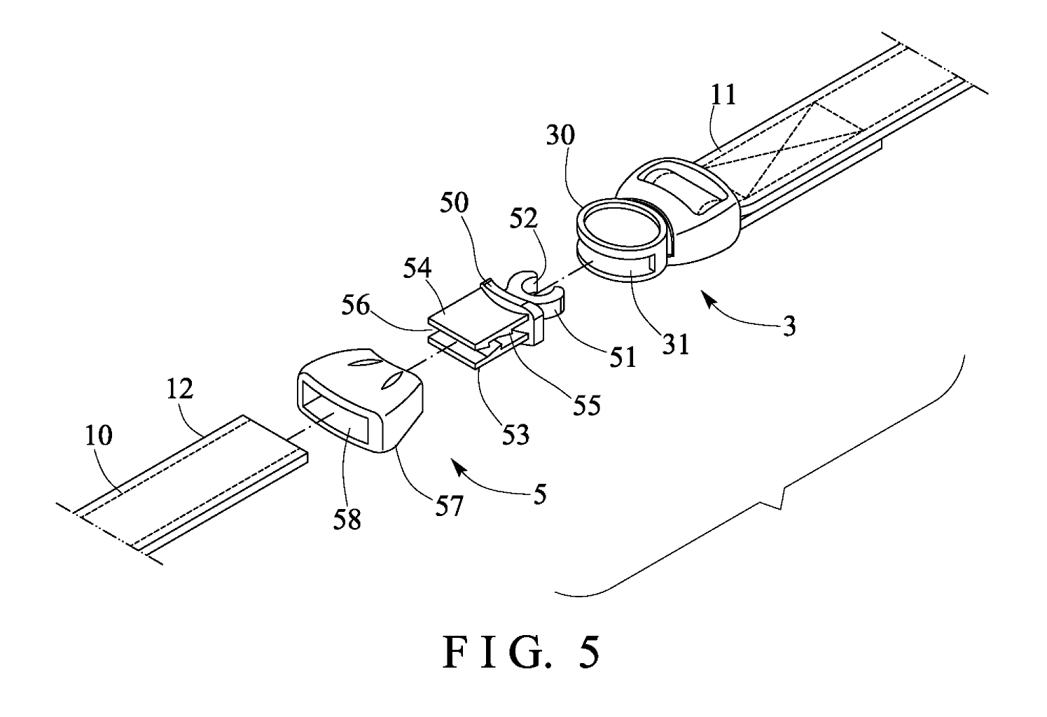

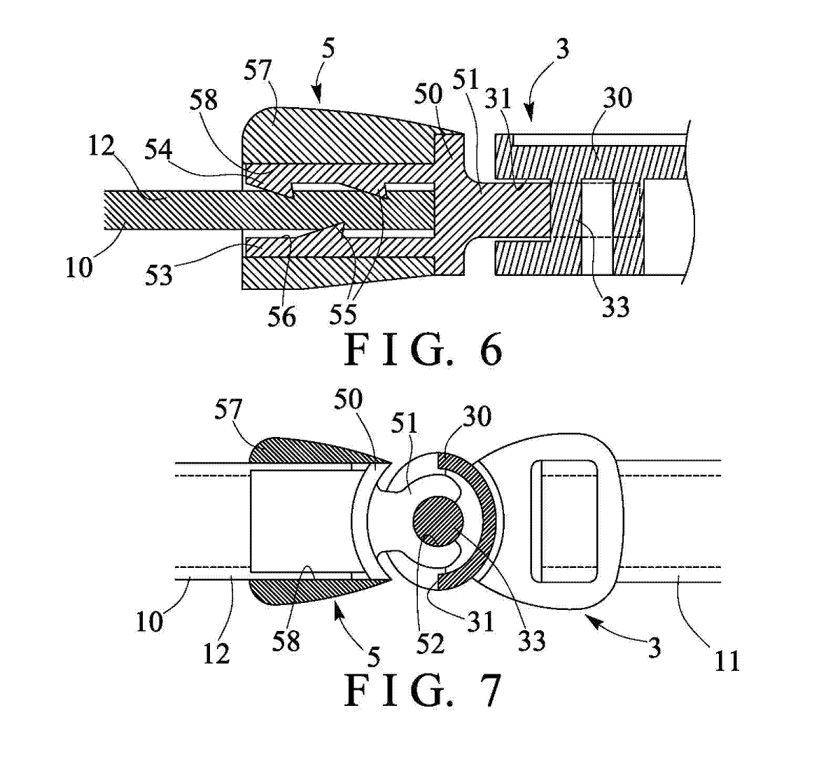

Referring to the drawings, and initially to FIGS. 1-7, a safety pet collar device in accordance with the present invention comprises a belt member 10 including one or first end portion 11, and another or second end portion 12, and a male buckle device 3 and a female buckle device 5 attached or mounted or secured to the end portions 11, 12 of the belt member 10 for engaging onto the neck portion of the pet. The male buckle device 3 is solidly and stably attached or mounted or secured to the one or first end portion 11 of the belt member 10, and includes a housing or receptacle 30 having a compartment or chamber 31 formed therein, and having a circular or cylindrical axle or tongue or male element 33 formed or provided therein and extended into the chamber 31 of the receptacle 30, and having a circular cross section (FIGS. 6-8).

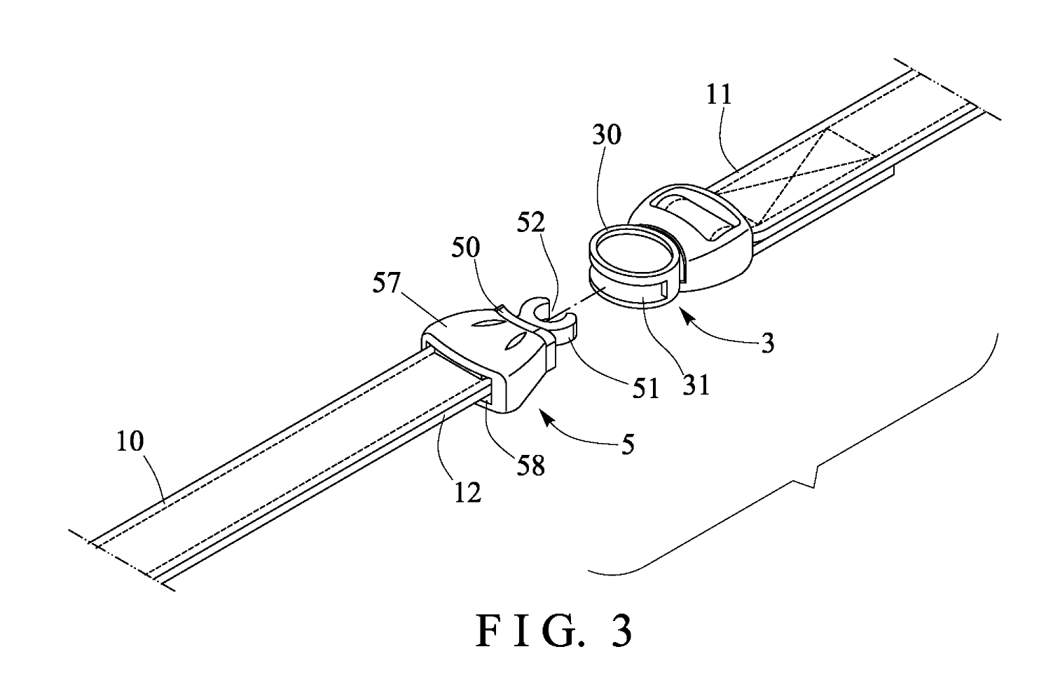

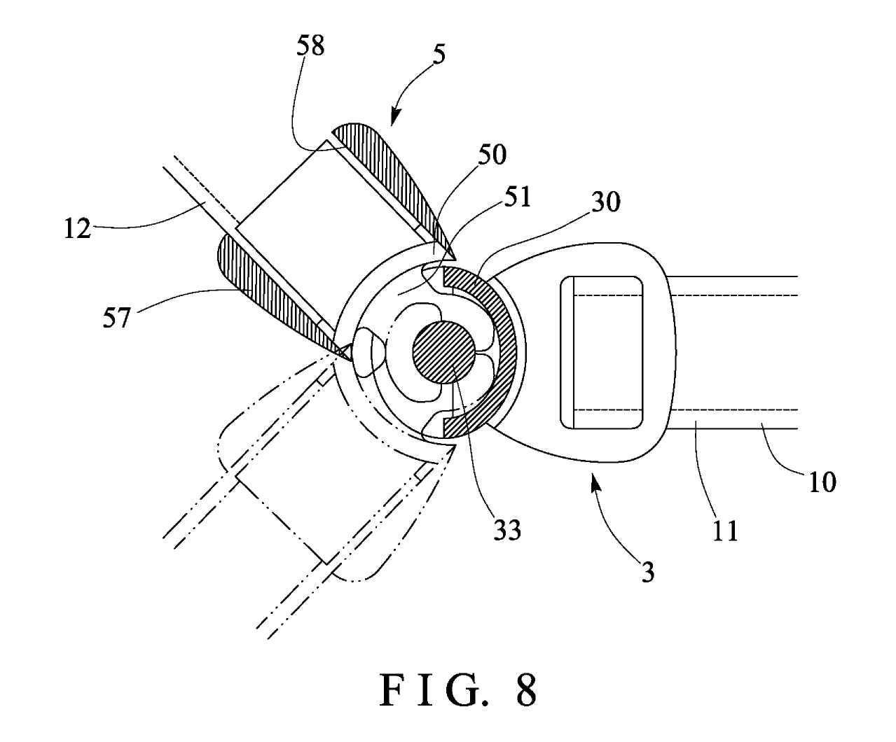

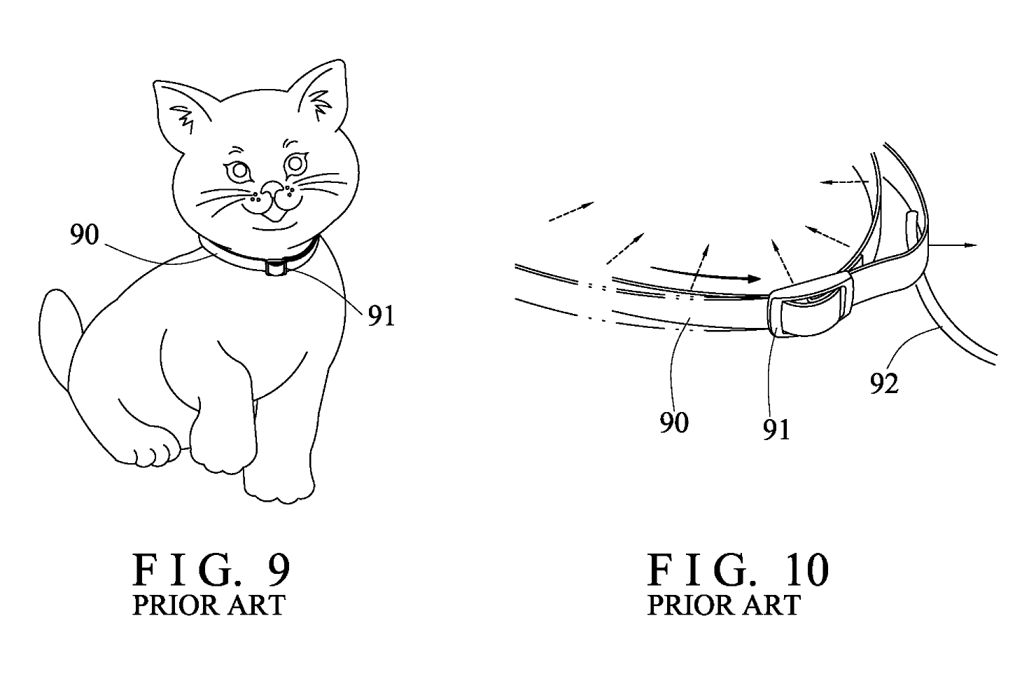

The female buckle device 5 includes a wall member or carrier 50 and a female element 51 attached or mounted or secured to the carrier 50 and/or extended from the carrier 50 and/or formed integral with the carrier 50, and the female element 51 includes a circular or cylindrical opening 52 formed therein (FIGS. 3-5) for pivotally or rotatably receiving or engaging with the corresponding circular or cylindrical tongue or male element 33 of the receptacle 30 and/or of the female buckle device 5 and for allowing the male buckle device 3 and the female buckle device 5 to be pivoted or rotated relative to each other, best shown in FIG. 8.

As shown in FIGS. 3-4 and 6, the female buckle device 5 further includes two ears or flaps 53, 54 extended from the carrier 50 and located or faced or directed away from the female element 51 and offset or spaced or separated from each other for forming or defining a gap or space 56 between the flaps 53, 54, and the flaps 53, 54 each include one or more projections or hooks or teeth 55 extended therefrom, and extended into the space 56 that is formed or defined between the flaps 53, 54, and/or extended toward the other flap 54, 53, for engaging with the other or second end portion 12 of the belt member 10, and for solidly and stably anchoring or retaining or securing the belt member 10 to the female buckle device 5.

The female buckle device 5 further includes a control ferrule or barrel or casing 57 having a chamber or compartment 58 formed therein for slidably receiving or engaging with the other or second end portion 12 of the belt member 10 and the flaps 53, 54, and for allowing the flaps 53, 54 to be forced or moved toward each other with the flaps 53, 54, and thus for allowing the teeth 55 of the flaps 53, 54 to be forced to engage into the other or second end portion 12 of the belt member 10 (FIG. 6), and thus for allowing the other or second end portion 12 of the belt member 10 and the flaps 53, 54 of the female buckle device 5 to be solidly and stably secured and retained together.

In operation, as shown in FIG. 8, the male buckle device 3 and the female buckle device 5 may be pivoted or rotated relative to each other. in addition, the male buckle device 3 is solidly and stably attached or mounted or secured to the one or first end portion 11 of the belt member 10, and the female buckle device 5 is solidly and stably attached or mounted or secured to the other or second end portion 12 of the belt member 10 and may not be slid or moved or adjusted relative to the end portions 11, 12 of the belt member 10 such that the belt member 10 will not be shortened inadvertently, and such that the pet will not be hurt by the pet collar device inadvertently.

Accordingly, the safety pet collar device in accordance with the present invention includes an improved structure or configuration for preventing the belt member from being shortened and for preventing the pet from being hurt by the pet collar device inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pet collar device comprising:
a belt member including a first end portion and a second end portion,
a male buckle device attached to said first end portion of said belt member, and including a male element,
a female buckle device including a carrier, a female element extended from said carrier for engaging with said male element, and two flaps extended from said carrier and spaced from each other for forming a space between said flaps, and for receiving said second end portion of said belt member, and
a casing including a compartment formed in said casing for receiving and engaging with said second end portion of said belt member and said flaps and for forcing said flaps to engage with said second end portion of said belt member.

2. The pet collar device as claimed in claim 1, wherein said male buckle device includes a receptacle having a chamber formed in said receptacle, said male element is extended into said chamber of said receptacle.

3. The pet collar device as claimed in claim 1, wherein said male element includes a circular cross section, and said female element includes an opening engaged with said male element.

4. The pet collar device as claimed in claim 1, wherein said flaps each include at least one tooth extended into said space that is formed between said flap for engaging with said second end portion of said belt member and for solidly securing said belt member to said female buckle device.
